(19) United States
(12) Patent Application Publication
(10) Pub. No.: US 2003/0112883 A1
(43) Pub. Date: Jun. 19, 2003

(54) Method and apparatus for bi-directional communication in systems broadcasting multi-carrier signals

(76) Inventors: David Wayne Ihrie, Princeton Junction, NJ (US); Alfonse Anthony Acampora, Staton Island, NY (US); Richard Michael Bunting, Hamilton, NJ (US); Frank Bowen Lang, Princeton Junction, NJ (US); Frederick John Vannozzi, Bordentown, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(21) Appl. No.: 10/137,808

(22) Filed: May 2, 2002

Related U.S. Application Data
(60) Provisional application No. 60/339,671, filed on Dec. 13, 2001.
(60) Provisional application No. 60/339,672, filed on Dec. 13, 2001.

(51) Int. Cl. H04L 27/28; H04K 1/10

(52) U.S. Cl. 375/260

(57) ABSTRACT

A method and apparatus for providing bi-directional communication in systems broadcasting multi-carrier signals removes at least one sub-carrier to form an intra-spectral gap within a multi-carrier broadcast signal. The intra-spectral gap is used to provide a bi-directional channel for propagating ancillary data signals between network elements in a broadcast communication system.

### CROSS-REFERENCE TO RELATED APPLICATIONS

This application claims benefit of U.S. provisional patent applications serial Nos. 60/339,671 and 60/339,672, both filed Dec. 13, 2001. Each of the aforementioned patent applications is herein incorporated by reference.

### GOVERNMENT RIGHTS IN THIS INVENTION

This invention was funded in part by the U.S. government under contract number DAAB07-01-9-L504, U.S. Army Communications-Electronic Command (CECOM). The U.S. government may have certain rights in this invention.

### BACKGROUND OF THE INVENTION

1. Field of the Invention

The present invention generally relates to digital communication systems and, more particularly, to a method and apparatus for bi-directional communication in systems broadcasting multi-carrier signals.

2. Description of the Related Art

Wireless communication networks, such as cellular telephone systems, have become increasingly popular as a means of communication. As a result, digital, broadband wireless communications infrastructures are proliferating around the world. Currently, there is increasing demand for bi-directional wireless data transmission, such as the request and transmission of stock quotes, weather reports, and news headlines. Present wireless communication networks, however, are limited when it comes to such bi-directional wireless data transmission. For example, cellular telephone infrastructures are based on multiple point-to-point sessions (i.e., calls). For data transmission purposes, this means that the bandwidth can be overwhelmed when many users repeatedly request the same data from the system.

In contrasts, broadcast transmission systems, such as digital television systems, can broadcast highly requested data once and reach all users. Broadcast communication systems, however, have not been used heavily for ancillary data transmission purposes since such systems typically employ only one-way transmissions. Therefore, there exists a need in the art for a method and apparatus for bi-directional communication in broadcast systems.

### SUMMARY OF THE INVENTION

The disadvantages associated with the prior art are overcome by a method and apparatus for providing bi-directional communication in systems broadcasting multi-carrier signals. The present invention removes at least one sub-carrier to form an intra-spectral gap within a multi-carrier broadcast signal. The intra-spectral gap is used to provide a bi-directional channel for propagating ancillary data signals. In one embodiment, a broadcast communication system comprises various network elements, such as a transmission system and a plurality of remote devices. The remote devices employ the bi-directional channel for communicating with the transmission system or other remote devices. In this manner, the present invention advantageously provides a bi-directional channel between remote devices and a transmission system, or a bi-directional channel for implementing a peer-to-peer network among a plurality of remote devices.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of a bi-directional broadcast communication system embodying the principles of the present invention;

FIG. 2 depicts a block diagram showing one embodiment of a transmitter in the broadcast communication system of FIG. 1;

FIG. 3 depicts a block diagram showing another embodiment of a transmitter in the broadcast communication system of FIG. 1;

FIG. 4A graphically illustrates a COFDM spectrum;

FIG. 4B graphically illustrates a COFDM spectrum having an intra-spectral gap in accordance with the present invention;

FIG. 4C graphically illustrates a bi-directional channel of the present invention;

FIG. 5 depicts a block diagram showing one embodiment of a filter device for use in the transmitters of FIGS. 2 and 3;

FIG. 6 depicts a block diagram showing one embodiment of a transmission system embodying the principles of the present invention;

FIG. 7 depicts a block diagram showing another embodiment of a transmission system embodying the principles of the present invention; and

FIG. 8 is a table illustrating the relationship between the amount of sub-carriers removed from the COFDM spectrum versus the signal-to-noise ratio for various modulation modes.

### DETAILED DESCRIPTION OF THE PREFERRED EMBODIMENT

The present invention is a method and apparatus for bi-directional communication in systems broadcasting multi-carrier signals. The present invention provides bi-directional channels imbedded within multi-carrier broadcast signals. In particular, the bi-directional channels reside in intra-spectral gaps created within the multi-carrier broadcast signals by selectively removing sub-carriers thereof. The bi-directional channels can be used to provide return paths to the broadcast system, and/or to provide communication channels between client devices in a peer-to-peer network. Although the principles of the present invention are particularly applicable to terrestrial digital video broadcasting (DVB-T) systems employing coded orthogonal frequency division multiplexed (COFDM) signals, and shall be described in this context, those skilled in the art will understand from the teachings herein that the principles of the present invention are also applicable to other digital broadcast systems including, but not limited to, digital audio broadcasting (DAB) radio systems.

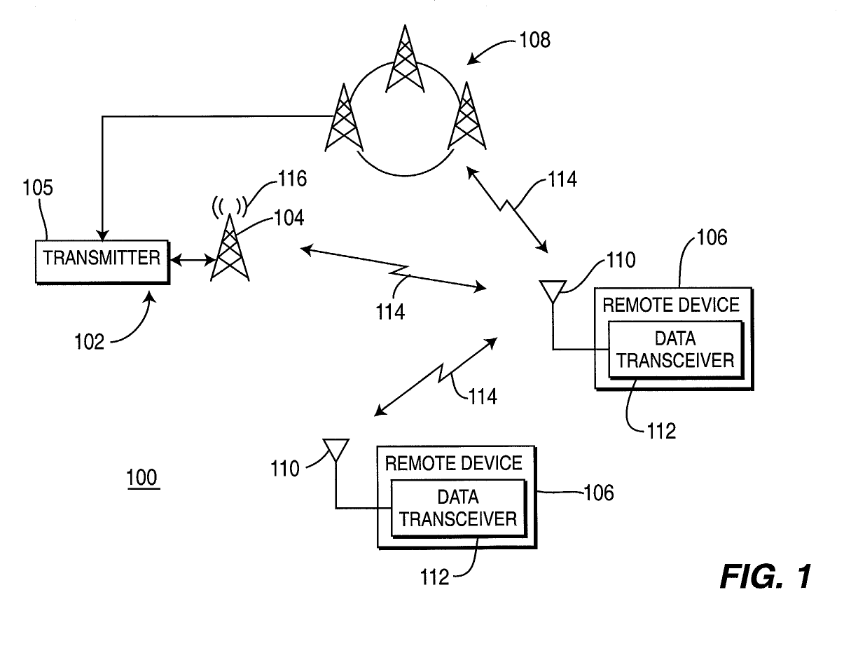

FIG. 1 depicts a block diagram of a bi-directional broadcast communication system 100 embodying the principles of the present invention. The system 100 comprises various network elements such as a transmission system 102, a plurality of remote devices 106 (two are shown), and a network of wireless base stations 108. The transmission system 102 comprises a transmitter 105 and a broadcast antenna 104. Each of the remote devices 106 comprises an antenna 110 and a data transceiver 112. The transmission system 102 broadcasts multi-carrier signals 116, such as COFDM signals. For uniformity and ease of understanding in the following description, multi-carrier broadcast signals 116 are contemplated to be COFDM signals though other broadcast multi-carrier signals, such as orthogonal frequency division multiplexed (OFDM) signals, can be used with the present invention.

In accordance with the present invention, each of the remote devices 106 employs an antenna 110 and a data transceiver 112 for transmitting data to, and receiving data from, other network elements over bi-directional channels 114. For example, one of the remote devices 106 can transmit and receive data from the transmission system 102, the network of wireless base stations 108, and another one of the remote devices 106. In any case, the bi-directional channels 114 are located in intra-spectral gaps formed in the spectra of multi-carrier broadcast signals 116. As described in more detail below, the intra-spectral gaps are created by removing particular sub-carriers in the COFDM signals 116. COFDM copes well with co-channel narrowband interference that can be caused by carriers of existing analog and digital services. As a result, COFDM signals 116 can tolerate imbedded bi-directional channels 114 with little or no perceptible degradation to the primary broadcast data (e.g., television images). The present invention advantageously provides bi-directional channels buried within the COFDM broadcast signals 116. The bi-directional channels can be used for full- or half-duplex communication between the remote devices 106 and other network elements.

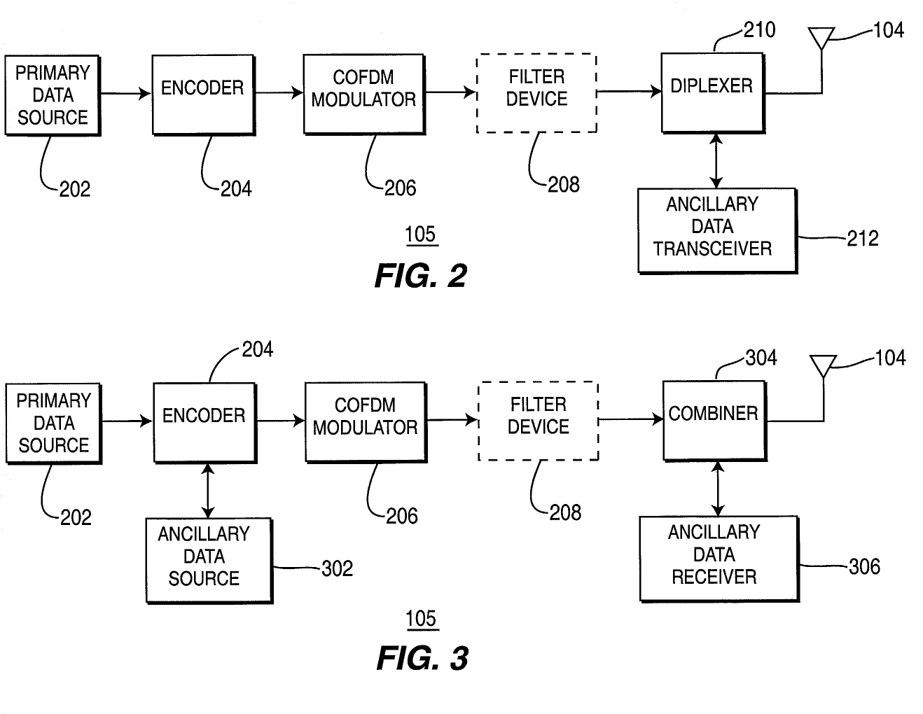

FIG. 2 depicts a block diagram showing one embodiment of the transmitter 105. The transmitter 105 comprises a primary data source 202, an encoder 204, a COFDM modulator 206, a diplexer 210, and an ancillary data transceiver 212. The transmitter 105 optionally comprises a filter device 208. The primary data source 202 supplies primary broadcast data (e.g., television images) to the encoder 204, which generates an MPEG transport stream or data that complies with another digital video format. Encoder 204 can be a DVB-T encoder or like type digital encoders known in the art. The COFDM modulator 206 modulates the output of the encoder 204 onto a predetermined number of sub-carriers comprising the COFDM spectrum for a particular broadcast channel. For example, in European DVB-T transmission, there can be many thousands of sub-carriers within an 8 MHz channel.

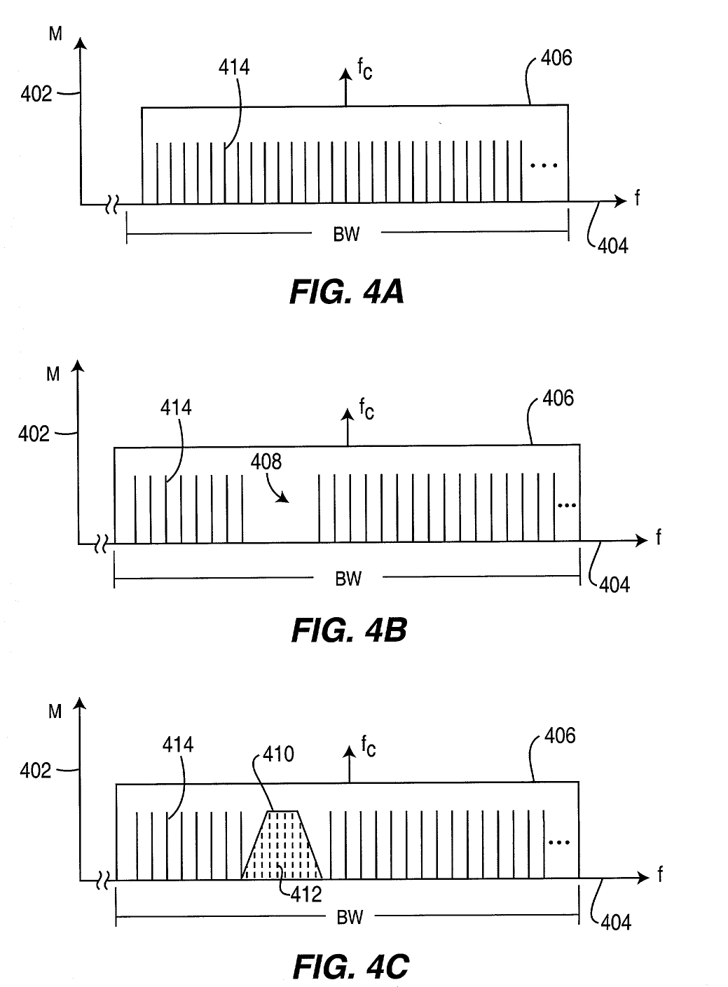

An exemplary COFDM spectrum is graphically depicted in FIG. 4A, where axis 402 generally represents magnitude and axis 404 generally represents frequency. As shown, a multiplicity of sub-carriers 414 occupy a channel bandwidth 406. The sub-carriers 414 modulate a transmit carrier of frequency f_{c}, corresponding to a particular broadcast channel. The COFDM modulator typically employs an inverse fast Fourier transform (IFFT) processor (not shown) to modulate the sub-carriers with the data. The COFDM modulation process is well known in the art.

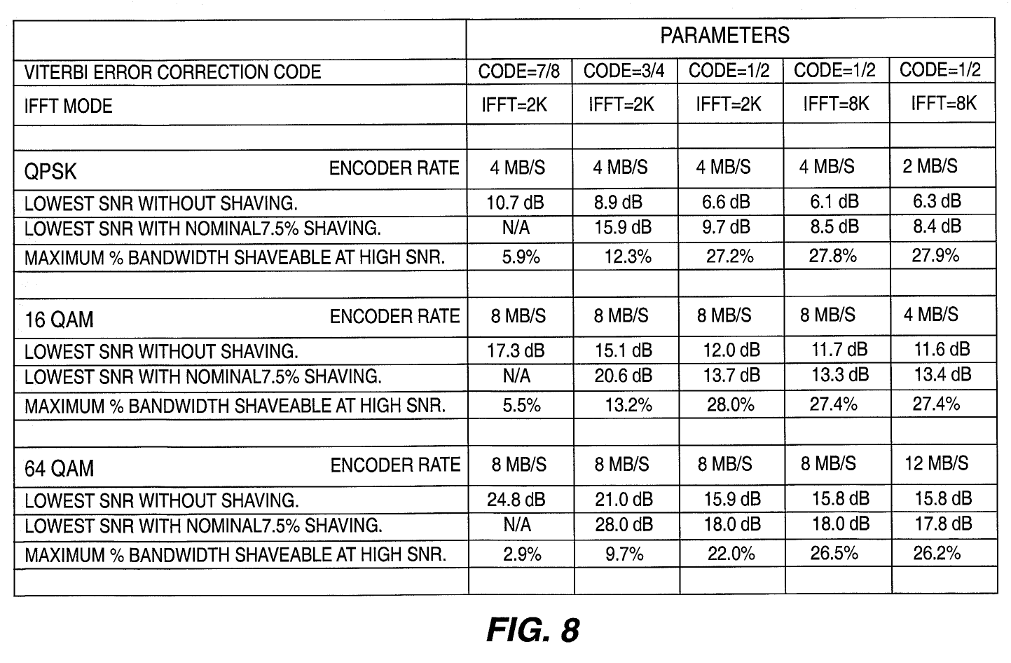

In one embodiment, the COFDM modulator 206 is capable of removing at least one sub-carrier from the COFDM spectrum by affecting the IFFT coefficients in the modulator 206. For example, the COFDM modulator 206 can include circuitry that offers a test mode for providing gaps within the COFDM spectrum for the purpose of intermodulation distortion measurements. Such COFDM modulators are commercially available from Unique Broadband Systems, located in Concord, Canada (e.g., models PT 5775 and PT 5780), and Tandberg, located in Oslo, Norway (e.g., model MT 5600). FIG. 4B graphically depicts a COFDM spectrum having an intra-spectral gap 408. Axes 402 and 404 are common with those of FIG. 4A. The present invention employs the intra-spectral gap 408 created by the COFDM modulator 206 to provide a bi-directional channel. The number of sub-carriers removed dictates the bandwidth of the bi-directional channel. As described below with respect to FIG. 8, the number of sub-carriers removed is preferably selected such that the primary broadcast signal suffers little or no perceptible degradation of its data. Although FIG. 4B shows a single gap 408, those skilled in the art will appreciate that one or more gaps 408 can be formed within the COFDM spectrum.

The output of the COFDM modulator 206 is coupled to the diplexer 210 along with the output of the ancillary data transceiver 212. The ancillary data transceiver 212 is capable of transmitting and receiving data over the bi-directional channel. The diplexer 210 feeds the ancillary and primary data signals to the broadcast antenna 104 for transmission. The broadcast antenna 104 is also capable of receiving ancillary data signals from remote devices, which are then coupled to the ancillary data transceiver 212 via diplexer 210. For example, a remote device can transmit a request over the bi-directional channel to the transmission system 102. The request is received by the broadcast antenna 104, and is coupled to the ancillary data transceiver 212. In turn, the ancillary data transceiver 212 can couple the requested data to the diplexer 210 for broadcast over the bi-directional channel. The remote device then receives the requested data. Communication between the ancillary data transceiver 212 and a remote device over the bi-directional channel can be full- or half-duplex communication.

The present invention can employ various modulation schemes when propagating signals over the bi-directional channel, as long as the bandwidth of the signals fits within the intra-spectral gap. For example, the bi-directional channel can propagate signals employing amplitude modulation (AM), frequency modulation (FM), COFDM modulation, or other modulation schemes known to those skilled in the art having a bandwidth that fits within the intra-spectral gap. An exemplary bi-directional channel is illustrated in FIG. 4C, where axes 402 and 404 are common with those of FIGS. 4A and 4B. As shown, ancillary carriers 412 are available for transmission within a bandwidth 410.

In an alternative embodiment, the output of the COFDM modulator 206 is coupled to a filter device 208. In the present embodiment, the COFDM modulator 206 generates all of the sub-carriers in the COFDM spectrum, and the filter device 208 filters the output of the COFDM modulator 206 to remove at least one sub-carrier for the bi-directional channel. The intra-spectral gap can be placed in any deterministic part of the COFDM spectrum. In addition, the skirt selectivity of the filter device 208 is preferably steep to avoid affecting the amplitude and phase of the sub-carriers adjacent to the stop-band of the filter device 208. The filter device 208 is amenable to any generic, in-place transmitter 105, so there is no need for a specially designed transmitter 105 in the transmission system 102.

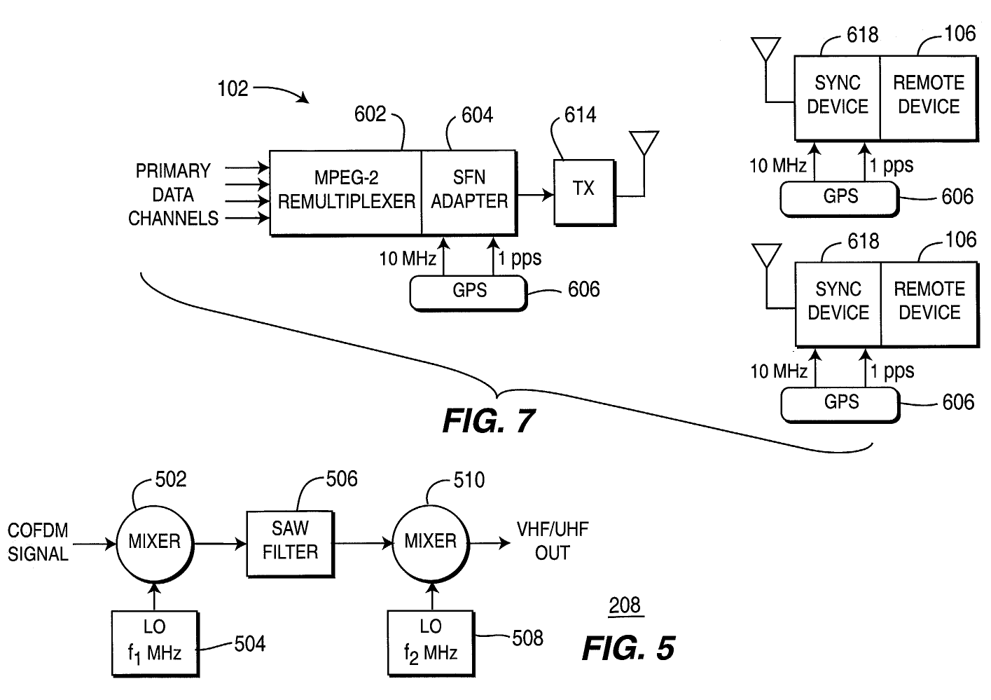

FIG. 5 depicts a block diagram showing one embodiment of a filter device 208. In the present embodiment, filter device 208 comprises a first mixer 502, a first local oscillator (LO) 504, a surface acoustic wave (SAW) filter 506, a second mixer 510, and a second LO 508. The COFDM signal is input to the first mixer 502. The first mixer 502 and the first LO 504 operate to convert the frequency of the COFDM signal to an intermediate frequency (IF). The frequency converted COFDM signal is coupled to the SAW filter 506, which is a fixed narrow-band notch filter. The SAW filter 506 removes a plurality of sub-carriers to provide bandwidth for the bi-directional channel. The placement of the intra-spectral gap within the COFDM spectrum is dictated by the frequency of the IF signal. That is, the first mixer 502 and the first LO 508 effectively “slide” the notch provided by the SAW filter 506 within the COFDM spectrum. Second mixer 510 and second LO 508 operate to convert the frequency of the modified COFDM signal output from the SAW filter 506 to a transmission frequency.

Alternatively, the SAW filter 506 can be a low-pass filter, preferably with a high degree of skirt selectivity. Frequency conversion by the first mixer 502 and the first LO 504 can place the COFDM spectrum in the passband of the SAW filter 506, which would eliminate the sub-carriers at the high-end of the spectrum. Varying the frequency of the first LO 504 allows the SAW filter 506 to encroach more or less into the COFDM spectrum, thereby varying the bandwidth of the bi-directional channel. Those skilled in the art will appreciate that the ancillary service channel can be formed in the low-end of the COFDM spectrum by employing a high-pass filter in place of the low-pass filter, or by employing inverted spectrum techniques in the frequency conversion process of the first mixer 502 and first LO 504.

FIG. 3 depicts a block diagram showing another embodiment of the transmitter 105. Elements in FIG. 3 that are the same or similar to elements in FIG. 2 have been designated with identical reference numerals and are explained in detail above. As shown in FIG. 3, the transmitter 105 comprises the primary data source 202, the encoder 204, an ancillary data source 302, the COFDM modulator 206, the optional filter device 208, a combiner 304, and an ancillary data receiver 306. In this embodiment, ancillary data supplied by ancillary data source 302 is transported along with the primary data. That is, ancillary data that is to be transmitted to other network elements is encapsulated within the MPEG transport stream. An intra-spectral gap is still formed within the COFDM spectrum by either the COFDM modulator 206, or the filter device 208, as described above. In this embodiment, however, the bi-directional channel is only required to carry data from the remote devices 106 to the transmission system 102 or the wireless network 108. This results in minimal exclusion of COFDM sub-carriers at the transmitter 105. The output of the COFDM modulator 206 (or filter device 208) is coupled to the combiner 304. The combiner 304 operates to feed the broadcast antenna 104 for transmission. The combiner 304 also receives ancillary data from the remote devices 106 via broadcast antenna 104, which are coupled to the ancillary data receiver 306. In this manner, the present embodiment can provide for low-rate inquiry from the remote devices 106 with high-rate data transmission from the transmitter 105.

In yet another embodiment of the invention, a subset of COFDM sub-carriers is selected for the purpose of transmitting ancillary data from the transmitter 105 to other network elements, such as the remote devices 106. In this embodiment, the ancillary data source 302 provides external data symbols representing the ancillary data directly to the COFDM modulator 206, which modulates the selected subset of COFDM sub-carriers with the ancillary data. The COFDM modulator 206 comprises circuitry (not shown) for preempting primary data symbols with the external data symbols. Likewise, each of the remote devices 106 comprises circuitry (not shown) for recovering the external data symbols from the selected subset of sub-carriers.

The subset of sub-carriers should be chosen so as to avoid selecting sub-carriers in the intra-spectral gap, since these sub-carriers are removed for the bi-directional channel as described above. The subset of sub-carrier can comprise pilots, data only, or both. The subset of sub-carriers is preferably chosen to cause the least disruption to legacy receivers, thus preempting a large number of pilot carriers with the external data symbols should be avoided. In addition, the selected subset can comprise sub-carriers scattered throughout the COFDM spectrum or in a contiguous group. Generally, the indices of the selected sub-carriers can be chosen from a pseudo-random binary sequence. As described above, an intra-spectral gap is formed within the COFDM spectrum to provide a bi-directional channel. The intra-spectral gap can be provided by the COFDM modulator 206, or the filter device 208, substantially as described above.

As described above with respect to FIG. 1, remote devices 106 can also employ the bi-directional channel to communicate amongst themselves. That is, the remote devices 106 can comprise a peer-to-peer or ad hoc wireless network that communicates “through” the intra-spectral gaps formed in the broadcast COFDM spectrum. The remote devices 106 can communicate directly amongst themselves, or can communicate amongst themselves with the aid of the network of wireless base stations 108. Thus, the bi-directional channels are used to provide full- or half-duplex communication between the remote devices 106 in the broadcast environment.

As described above, the present invention forms a bi-directional channel within the COFDM spectrum by either removing sub-carriers in the COFDM modulator, or by filtering the output of the COFDM modulator to remove sub-carriers. In the embodiment where sub-carriers are removed in the COFDM modulator, the intra-spectral gap formed by IFFT manipulation is not entirely devoid of spectral energy. The gap contains transient energy bursts that arise from symbol-to-symbol changes of the IFFT orthogonal carrier modulation. The spectral structure of the gap is time variant (i.e., accruing from the symbol changes) rather than frequency invariant (i.e., always at the same frequencies). This transient phenomenon can present interference to any external signals transmitted in the gap, unless these external signals have a symbol rate and transition times that are synchronized to the surrounding COFDM symbols. Maximal efficiency and throughput of external data is achieved if this data modulates sub-carriers are disposed in the same position as those sub-carriers originally in the intra-spectral gap, and if this data has the same symbol rate and transition timing as the COFDM signal.

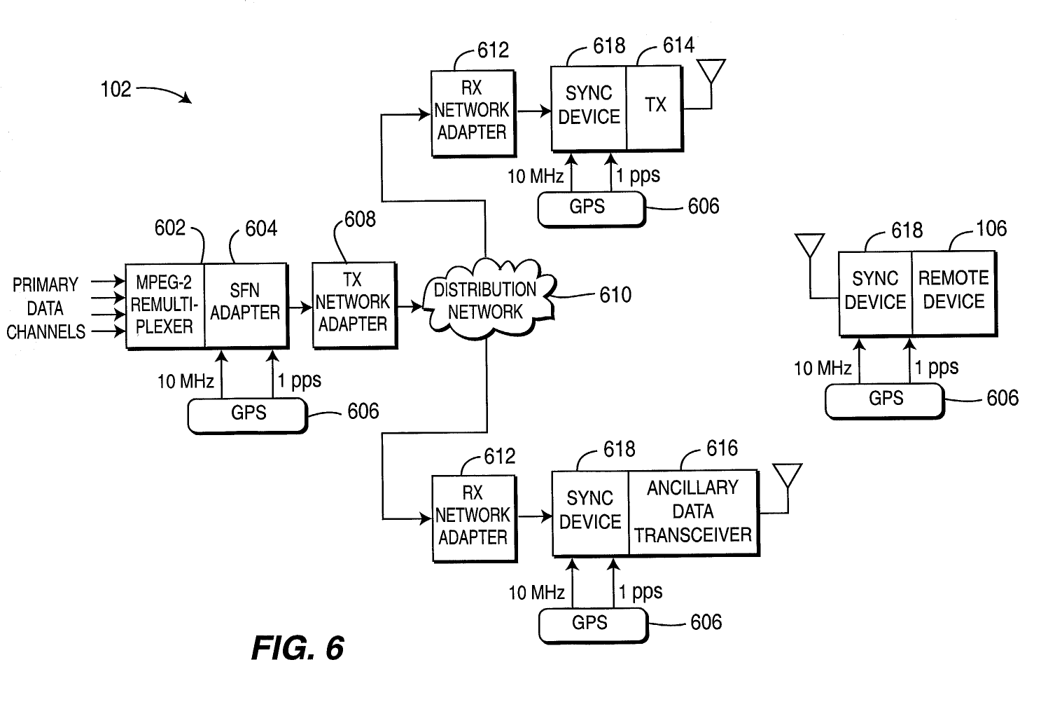

FIG. 6 depicts a block diagram showing one embodiment of the transmission system 102 and remote devices 106 for employing synchronized ancillary signals in bi-directional channels. In the present embodiment, the transmission system 102 is a single frequency network (SFN) system, such as an SFN system used in DVB-T transmission. As shown, the transmission system 102 comprises an MPEG-2 re-multiplexer 602, an SFN adapter 604, a global positioning system (GPS) time device 606, a transmission network adapter 608, a distribution network 610, a plurality of receive network adapters 612, a plurality of transmitters 614, and a plurality of ancillary data transceivers 616. Each of the transmitters 614 and the ancillary data transceivers 616 comprises a synchronization device 618 and a GPS time device 606. In addition, each of the remote devices 106 also comprises a synchronization device 618 and a GPS time device 606.

In operation, the MPEG-2 re-multiplexer 602 re-multiplexes the primary data from various input channels, and provides an MPEG-2 transport stream (TS) to the SFN adapter 604. The SFN adapter 604 receives a 1 pulse per second (pps) time reference, and a 10 MHz frequency reference, from the GPS time device 606. Although a GPS time reference is described herein, any external time reference can be used with the present invention. The SFN adapter 604 computes time and control information and builds a sequence of mega-frame initialization packets (MIPs) for insertion into the transport stream. The output of the SFN adapter 604 is an MPEG-2 compliant transport stream. The transmission network adapter 608 provides the modified transport stream (i.e., the MPEG-2 transport stream with the MIPs) to the distribution network 610.

The distribution network 610 can comprises a high-speed terrestrial communication link, such as an ATM network, OC-3 fiber, and like type communication links known in the art. Communication link with variable latency, such as Ethernet links, are preferably avoided. Broadcast and satellite distribution networks can also be used as long as they transmit using bands that do not overlap with the primary COFDM broadcast band. The distribution network 610 in turn provides the transport stream having the MIPs to each of the plurality of receive network adapters 612. The output of each of the receive network adapters 612 is coupled to either one of the transmitters 614 or one of the ancillary data transceivers 616.

The transmitters 614 broadcast multi-carrier signals as described above with respect to FIG. 1. That is, each of the transmitters 614 generates multi-carrier signals having imbedded bi-directional channels. The ancillary data transceivers 616 transmit and receive multi-carrier ancillary data signals over the bi-directional channels. In a SFN network configuration, the transmitters 614 are disposed such that they have overlapping coverage areas. In addition, the ancillary data transceivers 616 are also disposed to have overlapping coverage areas. Thus, the transmitters 614 must be synchronized with each other to avoid broadcasting the same multi-carrier signal at different times and/or at different frequencies. The ancillary data signals must also be synchronized with each other, and with their respective multi-carrier signals to avoid the transient phenomenon described above.

As such, the synchronization devices 618 provide propagation time compensation by comparing the timing information within the MIPs with a reference time from a GPS time device 606. For the transmitters 614, the synchronization devices calculate the delay needed for SFN synchronization. For the ancillary data transceivers 616, the synchronization devices synchronize the multi-carrier ancillary data signals with their respective multi-carrier broadcast signals. That is, the transmitters 614 all provide an identically placed intra-spectral gap as described above, and the ancillary data transceivers 616 produces one or more ancillary data carriers that are synchronized in symbol rate and transition timing to the COFDM broadcast signal using the information derived from the MIPs. Each of the one or more ancillary data carriers preferably occupies the same position as those sub-carriers originally in the intra-spectral gap for maximal efficiency. As described above, these synchronized ancillary data carriers can employ various modulation schemes.

FIG. 7 depicts a block diagram showing another embodiment of the transmission system 102 and remote devices 106 for employing synchronized ancillary data signals in bi-directional channels. Elements that are similar to those shown in FIG. 6 have been designated with identical reference numerals and are described in detail above. In the present embodiment, the transmission system 102 is a multiple frequency network (MFN), such as an MFN used in DVB-T transmission. As shown, the transport stream from the MPEG-2 re-multiplexer is coupled to the SFN adapter 604. The present invention advantageously employs the SFN adapter 604, which is ordinarily not used in the MFN configuration, to insert a sequence of MIPs as described above. The modified transport stream having the MIPs is coupled to the transmitter 614, which generates multi-carrier broadcast signals having imbedded bi-directional channels as described above. The remote devices 106 extract the MIPs using the synchronization device 618 and synchronizes the ancillary data signals with their respective multi-carrier broadcast signals in both symbol and transition timing. Synchronism of ancillary data signal symbol timing to the over-the-air symbol timing avoids an inter-symbol interference present in the intra-spectral gaps provided by the present invention for bi-directional communication.

FIG. 8 is a table illustrating the relationship between the amount of sub-carriers removed from the COFDM spectrum versus the signal-to-noise ratio for various modulation modes. The maximum percentage of the full bandwidth that can be “shaved” (i.e., removal of sub-carriers for the bi-directional channel), in the absence of any signal impairments (i.e., high signal-to-noise ratio (SNR)), is shown for three modulation modes: quadrature phase-shift keying (QPSK), 16 level quadrature amplitude modulation (QAM), and 64 level QAM. As shown, the maximum percentage shaveable at high SNR ranges from a minimum of 2.9% for the most complex modulation mode (64 QAM) with the least Viterbi error correction (code=⅞) to a maximum of 27.9% for the least complex modulation mode (QPSK) with the most Viterbi correction (code=½). The table also shows the lowest SNR (with additive Gaussian noise) that will produce just noticeable distortions in the received image data without shaving, and the reduction in SNR (i.e., loss margin) that occurs with exemplary 7.5% shaving (i.e., 7.5% of the COFDM bandwidth is shaved to produce the intra-spectral gap for the bi-directional channel).

While the foregoing is directed to the preferred embodiment of the present invention, other and further embodiments of the invention may be devised without departing from the basic scope thereof, and the scope thereof is determined by the claims that follow.

1. A method of communicating between network elements in a broadcast communication system comprising:
removing at least one sub-carrier to form an intra-spectral gap within a multi-carrier broadcast signal; and
employing the intra-spectral gap to provide a bi-directional channel adapted to propagate ancillary data signals.

2. The method of claim 1 wherein the step of removing comprises:
filtering the multi-carrier broadcast signal to remove the at least one sub-carrier from the multi-carrier broadcast signal.

3. The method of claim 1 wherein the step of removing comprises:
removing the at least one sub-carrier from the multi-carrier broadcast signal by affecting inverse fast Fourier transform (IFFT) coefficients within a modulator.

4. The method of claim 1 wherein the step of employing comprises:
transmitting ancillary data signals over the bi-directional channel from a remote device to another network element.

5. The method of claim 4 wherein the step of employing further comprises:
transmitting ancillary data signals over the bi-directional channel from a transmission system to another network element.

6. The method of claim 5 wherein the step of transmitting ancillary data signals from the transmission system comprises at least one of:
propagating ancillary data signals over the bi-directional channel;
encoding ancillary data signals with broadcast data corresponding to the multi-carrier broadcast signals; and
modulating a selected subset of sub-carriers in the multi-carrier broadcast signal with ancillary data symbols.

7. The method of claim 4 wherein the other network element comprises a network element selected from the group consisting of a transmission system, a wireless base station, and a remote device.

8. The method of claim 1 wherein the multi-carrier broadcast signal comprises a coded orthogonal frequency division multiplexed (COFDM) signal.

9. The method of claim 4 further comprising:
comparing information derived from a megaframe initialization packet (MIP) with an external time reference to compute signal timing information; and
synchronizing the ancillary data signals with the multi-carrier broadcast signal using the signal timing information.

10. A broadcast communication system comprising:
a transmission system for broadcasting a multi-carrier signal, the transmission system removing at least one sub-carrier from the multi-carrier signal to create a bi-directional channel; and
a plurality of remote devices for transmitting and receiving ancillary data signals using the bi-directional channel.

11. The system of claim 10 wherein the transmission system comprises:
an encoder for encoding broadcast data;
a modulator for generating the multi-carrier signal from the encoded broadcast data; and
an ancillary data transceiver for transmitting and receiving ancillary data signals.

12. The system of claim 11 wherein the modulator is adapted to remove the at least one sub-carrier from the multi-carrier signal by affecting inverse fast Fourier transform (IFFT) coefficients in the modulator.

13. The system of claim 11 further comprising:
a filter device for removing the at least one sub-carrier from the multi-carrier signal.

14. The system of claim 13 wherein the filter device comprises:
a surface acoustic wave (SAW) filter; and
a frequency converter for positioning the frequency response of the SAW filter within the spectrum of the multi-carrier signal.

15. The system of claim 10 wherein the transmission system comprises:
an encoder for encoding broadcast data and ancillary data;
a modulator for generating the multi-carrier signal from the encoded broadcast and ancillary data; and
an ancillary data receiver for receiving ancillary data signals.

16. The system of claim 10 wherein the transmission system comprises:
a single frequency network (SFN) adapter for inserting a sequence of megaframe initialization packets (MIPs) into the multi-carrier signal.

17. The system of claim 16 wherein each of the plurality of remote devices comprises:
a timing device for generating an external time reference signal; and
a synchronization device for comparing time information in the sequence of MIPs with the external time reference signal to synchronize ancillary data signals with the multi-carrier signal.

18. The system of claim 10 further comprising:
a network of wireless base stations for receiving ancillary data signals supplied by the plurality of remote devices.

19. The system of claim 10 wherein the broadcast communication system comprises a terrestrial digital video broadcast (DVB-T) system and the multi-carrier signal comprises a coded orthogonal frequency division multiplexed (COFDM) signals.

20. An apparatus for providing bi-directional channels in a broadcast communication system comprising:
a modulator for generating a multi-carrier broadcast signal;
a means for removing at least one sub-carrier from the multi-carrier broadcast signal to create a bi-directional channel; and
an ancillary data transceiver for transmitting and receiving ancillary data signals using the bi-directional channel.

21. The apparatus of claim 20 wherein the means for removing at least one sub-carrier comprises circuitry within the modulator for affecting inverse fast Fourier transform (IFFT) coefficients to remove the at least one sub-carrier.

22. The apparatus of claim 20 wherein the means for removing at least one sub-carrier comprises a filter device for removing a plurality of sub-carriers from the multi-carrier broadcast signal.
